(19) United States
(12) Patent Application Publication
(10) Pub. No.: US 2025/0356369 A1
(43) Pub. Date: Nov. 20, 2025

(54) AUDITING QUALITATIVE PROPERTIES OF AN ENTITY

(71) Applicant: Christopher Creel, Atlanta, GA (US)

(72) Inventor: Christopher Creel, Atlanta, GA (US)

(21) Appl. No.: 19/199,994

(22) Filed: May 6, 2025

Related U.S. Application Data
(60) Provisional application No. 63/648,828, filed on May 17, 2024.

(51) Int. Cl. G06Q 30/018; G06Q 10/0635

(52) U.S. Cl. CPC G06Q 30/018; G06Q 10/0635

(57) ABSTRACT

Embodiments of the invention relate to auditing qualitative properties of entities. The audits are automatically performed by generating an audit request including a scored assessment for a selected entity. The audits include associating a set of predetermined search queries corresponding to an industry to a name of the selected entity, the set of predetermined search queries including standards qualifications for the industry of the selected entity, prompts to search for specific evidence of satisfaction of each of the standards qualifications by the selected entity, prompts to record a location of the specific evidence, and scoring criteria for each of the standards qualifications. The audits include submitting the set of predetermined search queries to a generative artificial intelligence platform with a prompt to apply the set of predetermined search queries to the name of the selected entity and to score satisfaction of the set of predetermined search queries according to the scoring criteria to produce the scored assessment. The audits include receiving an electronic record of the scored assessment including the standards qualifications for the selected entity from the generative artificial intelligence platform. The audits include publishing the scored assessment to one or more entities. The audits include automatically generating and sending an electronic invitation to the selected entity to electronically submit rebuttal evidence to support changing one or more portions of the scored assessment based on proof of satisfaction of one or more of the standards qualifications in the rebuttal evidence.

### BACKGROUND

Consumers often look to auditors or reviewers when selecting products, services, or the like. Qualitative assessments or audits of companies, products, service, or the like typically take weeks or even months to complete and rely on the availability of qualified auditors to be completed. Further, such assessments may not have consistent audit criteria or practices from region to region.

### SUMMARY

Embodiments of the invention relate to methods and systems for automatically auditing qualitative properties of a selected entity extremely fast and at scale with expertise that was previously only available to one assessment at a time on a days or weeks long basis.

In an embodiment, a method of auditing qualitative properties of an entity is disclosed. The method incudes generating an audit request including a scored assessment for a selected entity. The method incudes associating a set of predetermined search queries corresponding to an industry to a name of the selected entity, the set of predetermined search queries including standards qualifications for the industry of the selected entity, prompts to search for specific evidence of satisfaction of each of the standards qualifications by the selected entity, prompts to record a location of the specific evidence, and scoring criteria for each of the standards qualifications. The method incudes submitting the set of predetermined search queries to a generative artificial intelligence platform with a prompt to apply the set of predetermined search queries to the name of the selected entity and to score satisfaction of the set of predetermined search queries according to the scoring criteria to produce the scored assessment. The method incudes receiving an electronic record of the scored assessment including the standards qualifications for the selected entity from the generative artificial intelligence platform. The method incudes publishing the scored assessment to one or more entities. The method incudes automatically generating and sending an electronic invitation to the selected entity to electronically submit rebuttal evidence to support changing one or more portions of the scored assessment based on proof of satisfaction of one or more of the standards qualifications in the rebuttal evidence.

In an embodiment, a system for generating and disseminating audit assessments is disclosed. The system includes a computing device having a memory storage on a non-transitory memory storage medium containing one or more operational programs including machine readable and executable instructions and a processor operably to and configured to access the memory storage and execute the one or more operational programs. The one or more operational programs of the system include instructions to generate an audit request including a scored assessment for a selected entity. The one or more operational programs of the system include instructions to associate a set of predetermined search queries corresponding to an industry to a name of the selected entity, the set of predetermined search queries including standards qualifications for the industry of the selected entity, prompts to search for specific evidence of satisfaction of each of the standards qualifications by the selected entity, prompts to record a location of the specific evidence, and scoring criteria for each of the standards qualifications. The one or more operational programs of the system include instructions to submit the set of predetermined search queries to a generative artificial intelligence platform with a prompt to apply the set of predetermined search queries to the name of the selected entity and to score satisfaction of the set of predetermined search queries according to the scoring criteria to produce the scored assessment. The one or more operational programs of the system include instructions to receive an electronic record of the scored assessment including the standards qualifications for the selected entity from the generative artificial intelligence platform. The one or more operational programs of the system include instructions to publish the scored assessment to one or more entities. The one or more operational programs of the system include instructions to automatically generate and send an electronic invitation to the selected entity to electronically submit rebuttal evidence to support changing one or more portions of the scored assessment based on proof of satisfaction of one or more of the standards qualifications in the rebuttal evidence.

In an embodiment, a method of auditing qualitative properties of an entity is disclosed. The method includes obtaining a name of a selected entity from an electronic source, including one or more of a database, website, direct electronic input, or electronic mail. The method includes automatically determining an industry of the selected entity. The method includes generating an audit request including a scored assessment for the selected entity. The method includes associating a set of predetermined search queries corresponding to the industry to a name of the selected entity, the set of predetermined search queries including standards qualifications for the industry of the selected entity, prompts to search for specific evidence of satisfaction of each of the standards qualifications by the selected entity, prompts to record a location of the specific evidence, scoring criteria for each of the standards qualifications, and criteria for determining a risk score for the selected entity based on the scored assessment. The method includes submitting the set of predetermined search queries to a generative artificial intelligence platform with a prompt to apply the set of predetermined search queries to the name of the selected entity, to score satisfaction of the set of predetermined search queries according to the scoring criteria to produce the scored assessment, and to determine the risk score for the selected entity based on the scored assessment. The method includes receiving an electronic record of the scored assessment including the standards qualifications for the selected entity from the generative artificial intelligence platform. The method includes publishing the scored assessment to one or more entities. The method includes automatically generating and sending an electronic invitation to the selected entity to electronically submit rebuttal evidence to support changing one or more portions of the scored assessment based on proof of satisfaction of one or more of the standards qualifications in the rebuttal evidence.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a flow chart of a method for auditing qualitative properties of an entity, according to an embodiment.

FIG. 2 is a schematic of a computing network for auditing qualitative properties of a selected entity, according to at least some embodiments.

FIGS. 3A and 3B are a flow diagram of an algorithm for auditing qualitative properties of an entity, according to an embodiment.

FIG. 4 is a block diagram illustrating associating a set of predetermined search queries corresponding to the industry to the name of the selected entity, according to an embodiment.

FIG. 5 is a schematic of a computing system 500 for executing any of the methods disclosed herein, according to an embodiment.

### DETAILED DESCRIPTION

Embodiments of the invention relate to methods and systems for automatically auditing qualitative properties of a selected entity extremely fast and at scale with expertise that was previously only available to one assessment at a time on a days, weeks, or even months long basis. The methods and systems disclosed herein provide a scored assessment for a selected entity based on an audit request. The scored assessment is carried out by associating a set of predetermined search queries corresponding to an industry to a name of the selected entity, the set of predetermined search queries including standards qualifications for the industry of the selected entity (includes scores), prompts to search for specific evidence of satisfaction of each of the standards qualifications by the selected entity, prompts to record location of the specific evidence, and scoring criteria for each of the standards qualifications. The search queries are submitted to a generative artificial intelligence platform with a prompt to apply the set of predetermined search queries to the name of the selected entity and to score satisfaction of the set of predetermined search queries according to the scoring criteria to produce the scored assessment. The scored assessment is sent from the generative artificial intelligence in a selected format and is published to one or more entities. An electronic invitation is automatically generated and sent to the selected entity to electronically submit rebuttal evidence to support changing one or more portions of the scored assessment based on proof of satisfaction of one or more of the standards qualifications in the rebuttal evidence. The scored assessment is remade using the rebuttal evidence.

By leveraging machine readable and executable interactions with, and using, generative artificial intelligence tools to automatically process sets of predetermined search queries corresponding to selected industries, the methods and systems disclosed herein provide accurate auditing of qualitative properties of a selected entity on a minutes or seconds timeline. For example, the systems and methods disclosed herein have a turnaround time of less than 5 minutes, such as less than 2 minutes, or even less than 1 minute.

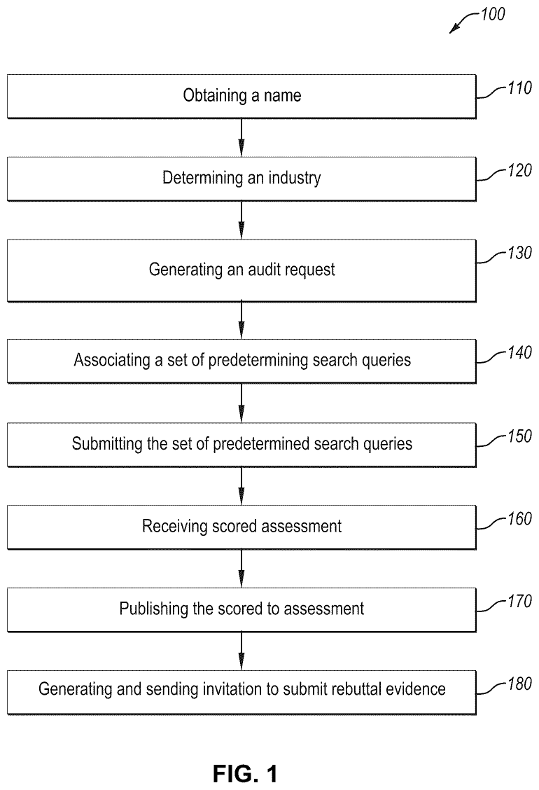

FIG. 1 is a flow chart of a method 100 for auditing qualitative properties of an entity, according to an embodiment. The method 100 includes an act 110 of obtaining a name of a selected entity from an electronic source, including one or more of a database, website, direct electronic input, or electronic mail; an act 120 of automatically determining an industry of the selected entity; an act 130 of generating an audit request including a scored assessment for the selected entity; an act 140 of associating a set of predetermined search queries corresponding to the industry to a name of the selected entity, the set of predetermined search queries including standards qualifications for the industry of the selected entity (includes scores), prompts to search for specific evidence of satisfaction of each of the standards qualifications by the selected entity, prompts to record location of the specific evidence, scoring criteria for each of the standards qualifications, and criteria for determining a risk score for the selected entity based on the scored assessment; an act 150 of submitting the set of predetermined search queries to a generative artificial intelligence platform with a prompt to apply the set of predetermined search queries to the name of the selected entity, to score satisfaction of the set of predetermined search queries according to the scoring criteria to produce the scored assessment, and to determine the risk score for the selected entity based on the scored assessment; an act 160 of receiving an electronic record of the scored assessment including the standards qualifications for the selected entity from the generative artificial intelligence platform; an act 170 of publishing the scored assessment to one or more entities; and an act 180 of automatically generating and sending an electronic invitation to the selected entity to electronically submit rebuttal evidence to support changing one or more portions of the scored assessment based on proof of satisfaction of one or more of the standards qualifications in the rebuttal evidence. In some embodiments, the method 100 may include more or fewer acts than the acts 110-180, such as by omitting or combining one or more of the acts 110-180. For example, the acts 110 and 120 may be omitted in some embodiments. In some embodiments, one or more of the acts 110-140 may be combined into a single act. In some embodiments, any one of the acts 110-180 may be broken into multiple acts. In some embodiments, the method 100 may include additional acts.

The an act 110 of obtaining a name of a selected entity from an electronic source, including one or more of a database, website, direct electronic input, or electronic mail may include obtaining the name of one or more of a product, a service, a service provider, a company, or the like. For example, the selected entity may be a product, company, service, or the like. Obtaining the name of the selected entity may include obtaining an email address of one or more personnel or email addresses of the selected entity.

Obtaining a name of a selected entity from an electronic source may include receiving the name from a requesting party, such as a party considering the services or products associated with the selected entity. The name of the selected entity may be entered into a system for carrying out the method 100 by the party or an audit requestor, the selected entity, or the like.

Obtaining a name of a selected entity from an electronic source may include obtaining the name from a download of a list of entities (e.g., for an industry, area, or any other grouping of entities). For example, a list of entities may be downloaded or entered from an electronic database, such as those available at Google business profiles, Dun & Bradstreet, Bloomberg, LinkedIn, Crunchbase, Better Business Bureau, Glassdoor.com, G2, Trustpilot, a chamber of commerce website, ZoomInfo.com, or the like. After the name of the selected entity is identified, the name bay be used to determine an industry, field, product type, or other category of the selected entity.

The act 120 of automatically determining an industry of the selected entity may include determining the industry from an electronic source. For example, the industry may be determined, inferred, or guessed based at least in part on data available at the electronic source. The selected entity may have a presence electronically accessible on the internet, such as via a website of the selected entity; website of an association, cooperative, reviewer, or the like of an industry associated with the selected entity; a repository of a third party (e.g., GitHub, GitLab); or the like. The presence may be electronically accessible to glean information about the selected entity. For example, a website may include information about the industry qualifications, awards, reviews, standards met, or the like of the selected entity. Accordingly, automatically determining an industry of the selected entity may include executing machine readable instructions to search for and obtain the industry of the selected entity from an electronic source. The machine readable and executable instructions may include instructions to send a prompt to a generative artificial intelligence platform to perform an analysis of the selected entity from one or more electronic sources and to guess, infer, prove, or otherwise determine the industry of the selected entity. The industry may be determined by querying one or more of a website of the selected entity, an industry website, a database containing names of companies and their corresponding industries, or an electronic communication providing the industry, or any other electronic source containing the industry (e.g., field, product, service) of the selected entity. Such queries may be carried out by a server, a computer, or a generative artificial intelligence platform according to machine readable and executable instructions to carry out the queries.

The act 120 of automatically determining an industry of the selected entity may include determining overview information of the selected entity from an electronic source. For example, one or more overview queries may be submitted to a generative artificial intelligence platform to locate and determine overview information of the selected entity. Such overview information may include key services, company size, company age, main location, company mission, industry match, linkedin page, G2 reviews, Glassdoor reviews, Trustpilot reviews, Youtube channel, contact email, or the like.

The act 130 of generating an audit request including a scored assessment for the selected entity may include generating an electronic request to produce a scored assessment of the named selected entity. Such an audit request may include producing electronic instructions to perform one or more of the acts of the method 100 for the selected entity (e.g., named selected entity). For example, the name of the selected entity may be applied into a machine readable and executable program for performing one or more of the acts 110-180. In some embodiments, generating an audit request including a scored assessment for a selected entity may include obtaining the name of the selected entity from an electronic source, including one or more of a database, website, direct electronic input, or electronic mail.

An audit requestor may enter a company name into a field for providing a name of a selected entity to be audited. In some examples, a name provided (and/or industry of the named entity) into a computing platform for performing the method 100 may be at least a portion of generating an audit request. For example, entering a list of names of selected entities into the computing platform may generate audit requests for a plurality of selected entities corresponding to the names. The generating the audit request may also associate the industry of the selected entity with the name.

The act 140 of associating a set of predetermined search queries corresponding to the industry to a name of the selected entity, the set of predetermined search queries including standards qualifications for the industry of the selected entity (includes scores), prompts to search for specific evidence of satisfaction of each of the standards qualifications by the selected entity, prompts to record location of the specific evidence, scoring criteria for each of the standards qualifications, and criteria for determining a risk score for the selected entity based on the scored assessment may include correlating the industry to the set of predetermined search queries relating to the industry stored in a database of the computing platform for carrying out the method 100.

The set of predetermined search queries may include machine readable and executable search queries composed to identify if the standards qualifications for the industry of the selected entity are met by the selected entity. The sets of predetermined search queries may include information, standards, practices, certifications, awards, or the like identified by industry experts as being indicative of quality practices, high performance, quality operation, a quality entity (e.g., company, product, service, etc.) in the industry, or the like (individually and collectively standards qualifications). By basing the sets of predetermined search queries on include information, standards, practices, certifications, awards, or the like identified by industry experts, the search queries may be later automatically performed without having to wait for auditors with industry expertise. The sets of predetermined search queries may be organized by category to provide qualitative analysis of the selected entity's characteristics, such as service or product quality, reliability, performance, management, practices, reputation, compliance (e.g., security, legal, or industry), community involvement, proactive communication, case studies, awards, thought leadership, SOC2, international standards, Agile practices, programming languages, testing practices, engineering practices, IaC experience, source control, requirements engineering, reputation, culture, change management, forecasting practices, team experience, open source, innovations, cloud experience, AI acceleration, continuous learning, recruitment excellence, diversity or the like (individually and collectively standards qualifications). Such categories may each have one or more associated search queries composed of the industry expert inputs to probe for evidence of various characteristics of the selected entity in each category. Accordingly, the predetermined search queries provide a qualitative picture of the selected entity's standards qualifications (e.g., rating in each category or characteristic) in the industry. Such standards qualifications may be broken down into the categories, each search query, or even presented as a whole for the entire set of predetermined search queries.

The predetermined search queries may be in the form of a question for a generative artificial intelligence prompt. For example, a search query may ask: Does the company have formal organizational change management practices? A search query may ask: What unique technological innovations or solutions has the company developed? A search query may ask: What expertise does the company have in reducing engineering risk? A search query may ask: Does the company have a defined cultural narrative focus on their customers and risk mitigation? A search query may ask: Is the company compliant with selected standard(s) (e.g., industry standard)? A search query may ask: Is there a positive public perception towards the company's reputation, particularly regarding its commitment to reducing engineering risk? A search query may ask: Does the company use formal requirements engineering methodologies? A search query may ask: Does the company using formal testing practices like TDD, regression testing, and automated testing? A search query may ask: Is the company committed to continuous learning for their team members? A search query may ask: Have the company made any significant open-source contributions? A search query may ask: Does the company use assessment-based recruiting practices to remove bias to find qualified candidates? A search query may ask: Does the company have a formal estimation and prioritization framework they use to accurately predict timelines? A search query may ask: Is the company a proactive partner with a clear communication strategy when working with clients? A search query may ask: Does the company use formal development practices? A search query may ask: Is the company ISO compliant? A search query may ask: Does the company have any outstanding complaints from a regulatory agency? A search query may ask: Does the company have a positive rating among reviewers? Further search queries may be used to probe any of the categories disclosed herein for the selected entity.

The predetermined search queries may include one or more of a corresponding search query identification number or corresponding plain language explanation of the question addressed by the search query. The predetermined search queries may include, or be used to form, prompts to search for specific evidence of satisfaction of each of the standards qualifications or characteristics thereof by the specific entity. For example, the set of predetermined search queries may be stored in prompt form in an database organized by industry. The name of the selected entity may be applied to the set of the predetermined search queries for an industry, based on identification of the industry of the selected entity, and the prompts may be output to a generative artificial intelligence platform for executing the search queries based on the prompts.

The set of predetermined search queries may include prompts to search for specific evidence of satisfaction of each of the standards qualifications by the selected entity. The set of predetermined search queries may include information, standards, practices, certifications, or the like included in (machine readable and executable code to generate) one or more prompts to a generative artificial intelligence platform to perform one or more searches for, and identification of specific proof, that the selected entity meets, exceeds, falls short of, lacks, or has no evidence of compliance with the information, standards, practices, certifications, or the like. Such specific evidence may include text, images, or other data from electronic sources, such as websites, databases, or the like that is relevant to the respective search queries.

The set of predetermined search queries may include prompts for directing the generative artificial intelligence platform to search for the evidence using character recognition, text recognition, image recognition, or any other techniques. The set of predetermined search queries may include prompts to search for the evidence in selected locations. Such prompts may be in the form of constraints to only search selected locations or to only consider selected types or categories of evidence. The set of predetermined search queries may include prompts to record a location of the specific evidence. For example, the electronic location (e.g., website, database, or the like) of the specific evidence identified by the generative artificial intelligence as being pertinent to the predetermined search query may be recorded and reported by the generative artificial intelligence based upon a prompt to do so in the predetermined search queries.

In some embodiments, the set of predetermined search queries may include overview queries, such as prompts, for determining the overview information of the selected entity from an electronic source as disclosed above. In such examples, the sets of predetermined search queries may include all sets of predetermined search queries along with machine readable and executable instructions to determine the industry of the selected entity (e.g., determine one or more items of overview information) and for the generative artificial intelligence platform to perform only the set of predetermined search queries corresponding to the industry.

The set of predetermined search queries may include other constraints, such as locations of evidence, sources of evidence, forms of evidence, time frames of evidence, or the like.

The set of predetermined search queries may include scoring criteria for each of the standards qualifications, such as thresholds for satisfaction of each of the predetermined search queries, standards qualifications, or characteristics. The scoring criteria may include rules for calculating the scored assessment. Such rules may include machine readable and executable instructions to provide a score for each of one or more specific search queries, standards qualifications, or characteristics. The rules may include instructions to provide a score based on one or more of an amount of electronically available evidence located for answering a search query, a minimum threshold of evidence sufficient a satisfy a search query, a numerical or qualitative level of evidence sufficient a satisfy a search query, to group (e.g., add) scores corresponding to a category together, to group scores corresponding to a characteristic together, to group all scores together, or the like. For example, the instructions may include instructions to add a scored result of each search query relating to a category together to give an overall score for the category and repeating the same for each category to present scores for each category (e.g., quality, compliance, reputation). The instructions may further include instructions to add up scores for all categories to provide a total score. Each of the scores may form at least a portion of the scored assessment. In some examples, the rules may include instructions to characterize a score within a selected threshold with a qualitative label, such as meets, exceeds, average, high performing, trusted, low quality, or the like.

The scoring criteria may include weights corresponding to each of the search queries, standards qualifications, or characteristics. The weights may be used to preferentially bias selected search queries, standards qualifications, or characteristics in determining (e.g., scoring) the satisfaction of the set of the predetermined search queries to form a scored assessment of the standards qualifications of the selected entity. In some embodiments, weights may be higher for data collected from selected sources, such as official websites or databases of industry, governmental organization (e.g., a regulatory body, municipality), standards organizations (e.g., ISO, IEC, ASME, AMA, ANSI, IEEE, OHICC, BBB), or the like.

The set of predetermined search queries may include prompts to provide a selected output for the scored assessment. The prompts to provide a selected output of the scored assessment may include prompts to output the scored assessment with one or more of a score for satisfaction of each search query, a score for satisfaction of a group or category of search queries, to provide plain language explanations of the selected entities' level of satisfaction of the predetermined search queries, to provide a plain language summary of the selected entities' characteristics, to provide a plain language summary of the selected entities' performance in one or more categories; to provide a plain language summary of the selected search queries (e.g., provide the prompts in plain language text) and the results of the audit relating thereto (e.g., provide summary of evidence of satisfaction of said search query).

The prompts to provide a selected output for the scored assessment may include a prompt to provide the output in one or more output formats, such as Java Script Object Notation (JSON), YAML, Extensible Markup Language (XML), Plain text format, Microsoft Word format, PDF format, Language type, or the like. The prompts to provide a selected output for the scored assessment may include a prompt to provide the output in one or more languages, such as English, Spanish, Mandarin, Japanese, French, German, or the like.

The prompts to provide a selected output for the scored assessment may include prompts to provide the scored assessment according to a selected organizational scheme, such as grouping the output by the predetermined search query, categories, or characteristics. The output may be a document with plain text documentation or explanations of the search query, evidence of satisfaction of the standards qualifications, location of the evidence of satisfaction of the standards qualifications (e.g., electronic address in a database or website), lack of evidence of satisfaction of the standards qualifications, presence of evidence to the contrary of satisfaction of the standards qualifications, name of the selected entity, industry of the selected entity.

The output may be a document with plain text documentation or explanations of a risk profile, a risk summary (discussed in more detail below), an overall risk score (e.g., standards qualifications met compared to total standards qualifications queried); a risk assessment for each search query including the question examined by the search query, the explanation of the results of the search queries, and explanation of importance of the standard qualification examined by the search query or category thereof.

The set of predetermined search queries may include criteria for determining a risk score for the selected entity or characteristics thereof, such as for a category. The risk score may include results of analysis of not meeting a standards qualification or a threshold thereof. For example, the risk score may include a numerical score accounting for the amount of standards qualifications or characteristics not met by the selected entity (e.g., where no or insufficient electronic evidence is found). The risk score may be based at least in part on weighted values for the corresponding standards qualifications or search queries not satisfied or not above a threshold level.

In some embodiments, the prompts may include prompts to subject evidence to one or more tests electronically available to the public. For example, the search queries may prompts to include tests or instructions to utilize testing services relevant to the industry, such as SonarCloud, Grammarly, Turnitin, or the like. The prompt may direct the generative artificial intelligence to take a piece of sample material (e.g., code, text, images) and subject it to quality testing.

An example prompt for search query is provided below. The example prompt may include:
Prompt: Is there evidence that the company follows formal code management practices essential for reducing engineering risk and financial peril? Look for indications of using version control systems like GitHub or GitLab and adherence to industry-standard code management methodologies. Evidence might include mentions of these tools in their development process, documentation, or case studies that showcase their code management strategies. Summarize any findings that reveal how these practices, or their absence, demonstrate the company's commitment to maintaining code integrity, facilitating collaboration, and efficiently tracking changes.
Note: In your assessment, focus solely on the content and implications of the provided data. Avoid mentioning the format or structure of the data provided (e.g., do not use terms like ‘snippet’), and do not reference the specifics of how the data was provided. Your response should be based purely on the information content and its relevance to the question.
Response Format: Respond with a JSON object containing three fields: ‘assessment’, and ‘explanation’. The ‘assessment’ field should choose exactly one option from: [‘no’, ‘unlikely’,‘likely’, ‘yes’, ‘unclear’]. Yes means there is direct evidence. No means there is no direct evidence, or there is direct evidence to the contrary. Likely means there is indirect evidence. Unlikely means there is no indirect evidence or there is indirect evidence to the contrary. Unclear means there is conflicting evidence (direct or indirect). In the ‘explanation’ field, provide an explanation of your assessment.
Response Constraints: Limit the explanation to 600 characters or less.

As noted above, search queries and the corresponding prompts may address any number of standards qualifications or characteristics of a selected entity. The above example prompt is intended to be only one example.

The act 150 of submitting the set of predetermined search queries to a generative artificial intelligence platform with a prompt to apply the set of predetermined search queries to the name of the selected entity, to score satisfaction of the set of predetermined search queries according to the scoring criteria to produce the scored assessment, and to determine the risk score for the selected entity based on the scored assessment may include electronically communicating the set of predetermined search queries (and prompts associated therewith) from a scored assessment platform to the generative artificial intelligence platform with the prompt to apply the set of predetermined search queries to the name of the selected entity. In some embodiments, the risk assessment may be optional.

Submitting the set of predetermined search queries to a generative artificial intelligence platform may include submitting one or more scoring criteria, one or more weights corresponding to each of the standards qualifications, rules for calculating the scored assessment, one or more prompts for constraints on the production of the scored assessment (e.g., limitations upon data sources from which the generative artificial intelligence platform is permitted to reference in answering the set of predetermined search queries), or one or more of any of the prompts, search queries, formats, or the like disclosed herein. For example, submitting the set of predetermined search queries to a generative artificial intelligence platform may include submitting prompts for outputting the scored assessment in a selected format includes one or more of text format output for the scored assessment, file format output for the scored assessment, information supplied in the scored assessment (e.g., summaries, risk scores), language, or any other format disclosed herein. The prompt may include instructions to electronically communicate the scored assessment to the scored assessment platform.

The generative artificial intelligence platform may include one or more of ChatGPT, Copilot, PaLM, Gemini, Scribe, Bard, Duet AI, DeepAI, Claude, a custom large language model (e.g., large language model trained, in part, on completed audits performed with the sets of predetermined search queries), or the like. For example, the prompt may include instructions for a first generative artificial intelligence platform to communicate with at least one more generative artificial intelligence platform to carry one or more search queries. Accordingly, the analysis and execution of the search queries as well as the generation of the scored assessment(s) may be carried out on one more third party generative artificial intelligence platforms. In some embodiments, the generative artificial intelligence platform may be located on servers or cloud storage of the audit platform.

In some embodiments, submitting the set of predetermined search queries to a generative artificial intelligence platform with a prompt to apply the set of predetermined search queries to the name of the selected entity, to score satisfaction of the set of predetermined search queries according to the scoring criteria to produce the scored assessment, and to determine the risk score for the selected entity based on the scored assessment may include submitting training data to the generative artificial intelligence platform. The training data may include sample sets of predetermined search queries and the corresponding scored assessments. The sample sets may be qualitatively vetted prior to submission to the generative artificial intelligence platform.

The act 160 of receiving an electronic record of the scored assessment including the standards qualifications for the selected entity from the generative artificial intelligence platform may include receiving the scored assessment in the selected format. Receiving an electronic record of the scored assessment may include receiving the scored assessment in the selected format and with any of the information disclosed herein. For example, receiving an electronic record of the scored assessment of the standards qualifications for the selected entity from the generative artificial intelligence platform may include receiving one or more of a score of each of the set of predetermined search queries, a total score of all of the set of predetermined search queries, at least one sub-score of at least one subset of the set of predetermined search queries grouped by a category of the standards qualifications.

The act 170 of publishing the scored assessment to one or more entities may include electronically communicating the scored assessment responsive to receiving the scored assessment from the generative artificial intelligence platform. For example, publishing the scored assessment to one or more entities may include automatically communicating an electronic copy of the scored assessment to one or more of an audit requesting entity or the selected entity. The scored assessment may be communicated via email, text message, web link or the like. Publishing the scored assessment to one or more entities may include automatically publishing the scored assessment on a database or website. Publishing the scored assessment may include electronically publishing the scored assessment in the selected format (e.g., in plain text) with any of the information for a scored assessment disclosed herein. In some embodiments, receiving an electronic record of the scored assessment of the standards qualifications for the selected entity from the generative artificial intelligence platform may include receiving the risk score or assessment for the selected entity, search queries, or categories disclosed herein.

The act 180 of automatically generating and sending an electronic invitation to the selected entity to electronically submit rebuttal evidence to support changing one or more portions of the scored assessment based on proof of satisfaction of one or more of the standards qualifications in the rebuttal evidence may include executing machine readable and executable instructions to carry out one or more of acts 110-170 again. For example, automatically generating and sending an electronic invitation to the selected entity to electronically submit rebuttal evidence to support changing one or more portions of the scored assessment based on proof of satisfaction of one or more of the standards qualifications in the rebuttal evidence may include executing machine readable and executable instructions to allow submission of rebuttal evidence via an email address of the recipient of the scored assessment, from email addresses at the domain of the selected entity, or via a link in the electronic invitation.

In some embodiments, automatically generating and sending an electronic invitation to the selected entity to electronically submit rebuttal evidence to support changing one or more portions of the scored assessment based on proof of satisfaction of one or more of the standards qualifications in the rebuttal evidence includes automatically generating and sending an electronic link to submit rebuttal evidence that is electronically linked to the scored assessment in an audit provider computing device (e.g., auditor computing platform).

In some embodiments, the method 100 may include obtaining industry standards from industry experts. In some embodiments, the method 100 may include writing a machine readable and executable search queries composed to cause a generative artificial intelligence platform to obtain and recognize evidence of satisfaction of the industry standards (e.g., standards qualification) to determine if the industry standards are met. The method 100 may include grouping the industry standards by industry type.

In embodiments, the method 100 includes an act of rescoring and republishing the scored assessment based on rebuttal evidence. The rescoring and republishing may be carried out as disclosed above for acts 140-170 based on the rebuttal evidence. For example, the audit platform may include instructions to perform one or more of acts 140-170 again using the rebuttal evidence. In some embodiments, the rescoring may be constrained only to the rebuttal evidence in view of the evidence already examined for the first scored assessment. In some embodiments, the act 180 may be performed after rescoring and republishing the scored assessment.

The method 100 may be carried out on a computing platform of the auditor (e.g., audit platform) including a computing system or a computer network.

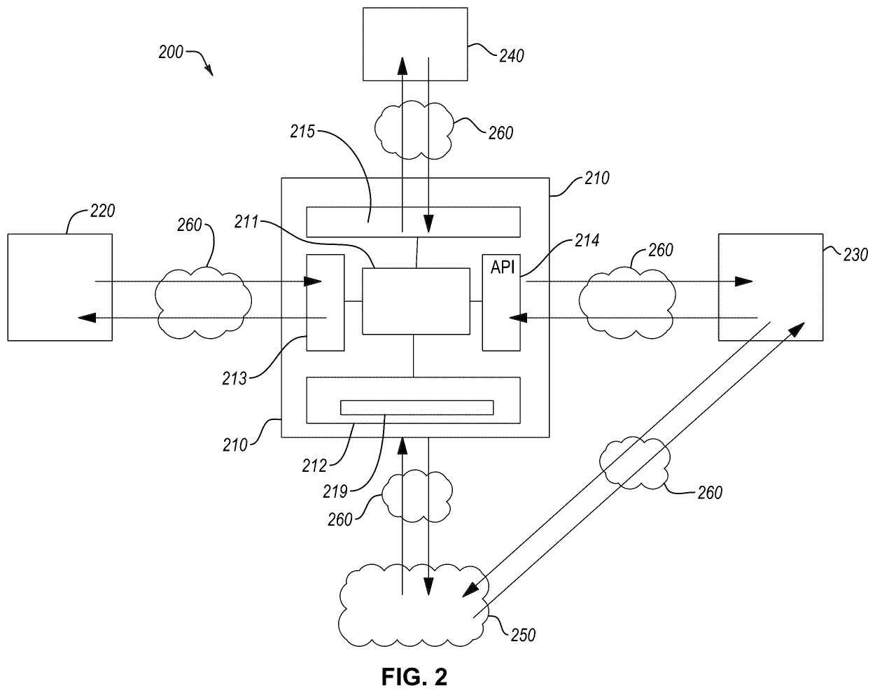

FIG. 2 is a schematic of a computing network 200 for auditing qualitative properties of a selected entity, according to at least some embodiments. The computing network 200 includes the audit platform 210, the client platform 220, the generative artificial intelligence platform 230, the selected entity platform 240, one or more public computing platforms 250, and one or more network connections 260. The computing network 200 may be used to carry out the method 100. For example, various parts of the computing network 200 may be utilized to carry out discrete portions of the method 100.

The audit platform 210 may include a computing device (e.g., computer, servers, cloud storage) having a memory storage 212 on a non-transitory memory storage medium containing one or more operational programs 219 including machine readable and executable instructions for carrying out one or more portions of the method 100. The computing device of the audit platform 210 includes a processor 211 operably coupled to the memory storage 212. The processor 211 is configured to access the memory storage 212 and execute the one or more operational programs 219 stored therein.

The one or more operational programs 219 including instructions to perform any of the acts of the method 100, or portions thereof, disclosed herein. For example, the one or more operational programs 219 may include machine readable and executable instructions to obtain the name of the selected entity from an electronic source, including one or more of a database, website, direct electronic input, or electronic mail, as disclosed herein.

The one or more operational programs 219 may include machine readable and executable instructions to generate an audit request including a scored assessment for a selected entity as disclosed herein.

The one or more operational programs 219 may include machine readable and executable instructions to associate a set of predetermined search queries corresponding to an industry to a name of the selected entity, the set of predetermined search queries including standards qualifications for the industry of the selected entity (includes scores), prompts to search for specific evidence of satisfaction of each of the standards qualifications by the selected entity, prompts to record location of the specific evidence, and scoring criteria for each of the standards qualifications as disclosed herein.

The one or more operational programs 219 may include machine readable and executable instructions to submit the set of predetermined search queries to a generative artificial intelligence platform with a prompt to apply the set of predetermined search queries to the name of the selected entity and to score satisfaction of the set of predetermined search queries according to the scoring criteria to produce the scored assessment. The instructions may include instructions to submit one or more constraints as disclosed herein, such as limitations upon data sources from which the generative artificial intelligence platform is permitted to reference in answering the set of predetermined search queries. The instructions may include and format instructions configured to prompt the generative artificial intelligence platform to output a response in one or more selected formats as disclosed herein.

The one or more operational programs 219 may include machine readable and executable instructions to receive an electronic record of the scored assessment including the standards qualifications for the selected entity from the generative artificial intelligence platform. Such instructions may include instructions on how to store the scored assessment in the memory storage 212. The instructions may include instructions to receive one or more of a score of each of the set of predetermined search queries, a total score of all of the set of predetermined search queries, at least one sub-score of at least one subset of the set of predetermined search queries grouped by a category of the standards qualifications from the generative artificial intelligence platform as disclosed herein.

The one or more operational programs 219 may include machine readable and executable instructions to publish the scored assessment to one or more entities. The instructions may include instructions for one or more electronic addresses to publish the scored assessment, such as to the audit requesting entity, a website, or the like. The machine readable and executable instructions to publish the scored assessment to one or more entities may include instructions to automatically communicate an electronic copy of the scored assessment to one or more of an audit requesting entity or the selected entity.

The one or more operational programs 219 may include machine readable and executable instructions to automatically generate and send an electronic invitation to the selected entity to electronically submit rebuttal evidence to support changing one or more portions of the scored assessment based on proof of satisfaction of one or more of the standards qualifications in the rebuttal evidence. The instructions may include instructions to automatically generate and send an electronic link to submit rebuttal evidence that is electronically linked to the scored assessment in a provider computing device. Such instructions may include instructions to send the link to an email address of the selected entity or one or more employees thereof, at an email address having the selected entity's domain.

The one or more operational programs 219 may include machine readable and executable instructions to receive the rebuttal evidence from the selected entity via an electronic link or from one or more email addresses from the selected entity (e.g., having the selected entity's domain).

The one or more operational programs 219 may include machine readable and executable instructions to resubmit the set of predetermined search queries to a generative artificial intelligence platform with a prompt to apply the set of predetermined search queries to the name of the selected entity and to score satisfaction of the set of predetermined search queries according to the scoring criteria to produce the scored assessment; receive an electronic record of the (re)scored assessment including the standards qualifications for the selected entity from the generative artificial intelligence platform; publishing the (re)scored assessment to one or more entities; and optionally, automatically generating and sending an electronic invitation to the selected entity to electronically submit rebuttal evidence to support changing one or more portions of the (re)scored assessment based on proof of satisfaction of one or more of the standards qualifications in the rebuttal evidence. In some embodiments, the consideration of the rebuttal evidence may be constrained to a limited set or single search query. In some embodiments, the consideration of the rebuttal evidence may be open to evidence effecting all of the search queries and results thereof.

The one or more operational programs 219 may include machine readable and executable instructions to submit the set of predetermined search queries to a generative artificial intelligence platform with a prompt to apply the set of predetermined search queries to the name of the selected entity including instructions to submit a prompt to determine a risk score for the selected entity based on the scored assessment, as disclosed herein. In such embodiments, the one or more operational programs 219 may include machine readable and executable instructions to receive an electronic record of the scored assessment of the standards qualifications for the selected entity from the generative artificial intelligence platform including instructions to receive the risk score from the generative artificial intelligence platform, as disclosed herein.

The audit platform 210 may include one or more application programing interfaces (APIs) 213-215 for controlling electronic communications between the audit platform 210 and one or more of the client platform 220, the generative artificial intelligence platform 230, the selected entity platform 240, or one or more public computing platforms 250. For example, the audit platform 210 may include API 213 having machine readable and executable instructions for controlling communication between the audit platform 210 computing device and an audit requestor at the client platform 220 (e.g. client computing device), such as to control communication of the audit request and scored assessment. The audit platform 210 may include API 214 having machine readable and executable instructions for controlling communication between the audit platform 210 computing device and a generative artificial intelligence tool at the generative artificial intelligence platform 230 (e.g., generative artificial intelligence computing device or servers), such as to control submission of the set of predetermined search queries (including prompts) and receipt of the scored assessment. The audit platform 210 may include API 215 having machine readable and executable instructions for controlling communication between the audit platform 210 computing device and the selected entity at the selected entity platform 240 (e.g., selected entity computing device), such as to control communication of the scored assessment, electronic invitation to submit rebuttal evidence, and receipt of the rebuttal evidence. The audit platform 210 may include one or more additional APIs (not shown) having machine readable and executable instructions for controlling communication between the audit platform 210 computing device and the public computing platforms 250, such as to control access to scored assessments.

Each of the client platform 220, the generative artificial intelligence platform 230, the selected entity platform 240, or one or more public computing platforms 250, may include one or more computing devices having memory storage and a processor operably coupled thereto for executing one or more operational programs stored in the memory storage. The computing device may include one or more personal computers, servers, cloud-based platforms, or the like. The memory storage of the generative artificial intelligence platform 230 may include a generative artificial intelligence tool stored therein, such as a large language model. For example, the generative artificial intelligence platform may include one or more of ChatGPT, DeepAI, Bard, Copilot, PaLM, Gemini, Claude, or the like.

The audit platform 210 and one or more of the client platform 220, the generative artificial intelligence platform 230, the selected entity platform 240, or one or more public computing platforms 250 may communicate with each other via the one or more network connections 260. The one or more network connections may include internet connections, local area networks, WiFi networks, Bluetooth connections, or any other electronic connection wherein data transmission is provided.

During use, the client platform 220 may communicate an audit request with the audit platform 210 via the network connection 260 and API 213. For example, a user at the client platform may request an audit of one or more selected entities by entering their names into the audit platform via the network connection 260 and API 213 into a web-based interface provided by the audit platform 210. A user may request an audit of one or more selected entities by entering an industry into the audit platform via the network connection 260 and API 213 into a web-based interface provided by the audit platform 210. The audit platform 210 may include and execute instructions to find names of selected entities in the industry identified by the user. In some examples, the audit platform 210 may include and execute instructions to access a database of names of selected entities on public computing platforms 250 (e.g., websites, databases, or the like stored thereon) and correlate the names to industries of the selected entities. Accordingly, a plurality of audit requests may be generated contemporaneously.

Responsive to receiving the audit request, the audit platform 210 may automatically determine if the selected entity has a known industry type. For example, the audit platform 210 may search the memory 212 for record of an industry type for the selected entity by the name of the selected entity. The audit platform 210 may access and search data on public computing platforms 250 via the network connection 260 for record of an industry for the selected entity by the name of the selected entity. Once identified, the industry may be correlated to the name of the selected entity the memory storage 212.

The audit platform 210 may then associate a set of predetermined search queries corresponding to the industry to a name of the selected entity, the set of predetermined search queries including standards qualifications for the industry of the selected entity (includes scores), prompts to search for specific evidence of satisfaction of each of the standards qualifications by the selected entity, prompts to record location of the specific evidence, scoring criteria for each of the standards qualifications, and criteria for determining a risk score for the selected entity based on the scored assessment, as stored or located in the audit platform 210.

The audit platform 210 may then submit the set of predetermined search queries to a generative artificial intelligence platform 230 with a prompt to apply the set of predetermined search queries to the name of the selected entity, to score satisfaction of the set of predetermined search queries according to the scoring criteria to produce the scored assessment, and to determine the risk score for the selected entity based on the scored assessment. The submission may be communicated to the generative artificial intelligence platform 230 via the network connection 260 and the API 214.

In applying the set of predetermined search queries, the generative artificial intelligence platform 230 may access and search data on public computing platforms 250 via the network connection 260 for evidence of satisfaction of the standards qualifications in the search queries (or prompts corresponding thereto). The generative artificial intelligence platform 230 may apply the set of predetermined search queries to the name of the selected entity, score satisfaction of the set of predetermined search queries according to the scoring criteria to produce the scored assessment based on the evidence found, and determine the risk score for the selected entity based in part on the scored assessment and evidence associated therewith. Once completed the generative artificial intelligence platform 230 may communicate the scored assessment and information associated therewith (e.g., risk scores, evidence locations) to the audit platform 210 via the network connection 260 and the API 214 responsive to the prompts in the predetermined set of search queries.

The audit platform 210 may receive the electronic record of the scored assessment including the standards qualifications for the selected entity from the generative artificial intelligence platform 230 via the network connection 260 and the API 214. Responsive thereto, the audit platform 210 may include and execute instructions to examine the audit report for one or more of content or format according to the prompts associated with the search queries corresponding thereto.

The audit platform 210 may include and execute instructions to publish the scored assessment to one or more entities, such as the client platform 220, the selected entity platform 240, or the public computing platform(s) 250. Such publication may be an electronic communication (e.g., email, website posting, database population) in a selected format, such as in TXT, PDF RTF, HTML, XML, or the like format. The electronic communication may include any of the formats disclosed herein such as language, content, file type, or the like.

The audit platform 210 may include and execute instructions to automatically generate and send an electronic invitation to the selected entity to electronically submit rebuttal evidence to support changing one or more portions of the scored assessment based on proof of satisfaction of one or more of the standards qualifications in the rebuttal evidence responsive to receiving the scored assessment. Such invitation may be communicated to the selected entity platform 240 via the network connection 260 and the API 215. The invitation may contain an electronic explanation and a link to provide the rebuttal evidence corresponding to one or more search queries to the audit platform 210. The API 215 may be programmed to only allow the rebuttal evidence corresponding to one or more search queries to the audit platform 210 via the link or via an email address containing the selected entity's domain (e.g., web or email domain).

The audit platform 210 may include and execute instructions to electronically examine the rebuttal evidence (e.g., image recognition, optical character recognition, content examination) to determine if the search query or standards qualification therein is satisfied by the rebuttal evidence. The audit platform 210 may include and execute instructions to rescore and republish the scored assessment based on the rebuttal evidence. The rescoring and republishing may be carried out as disclosed above for acts 140-170 based on the rebuttal evidence as disclosed herein. In some embodiments, the rescoring may be constrained only to the rebuttal evidence in view of the evidence already examined for the first scored assessment.

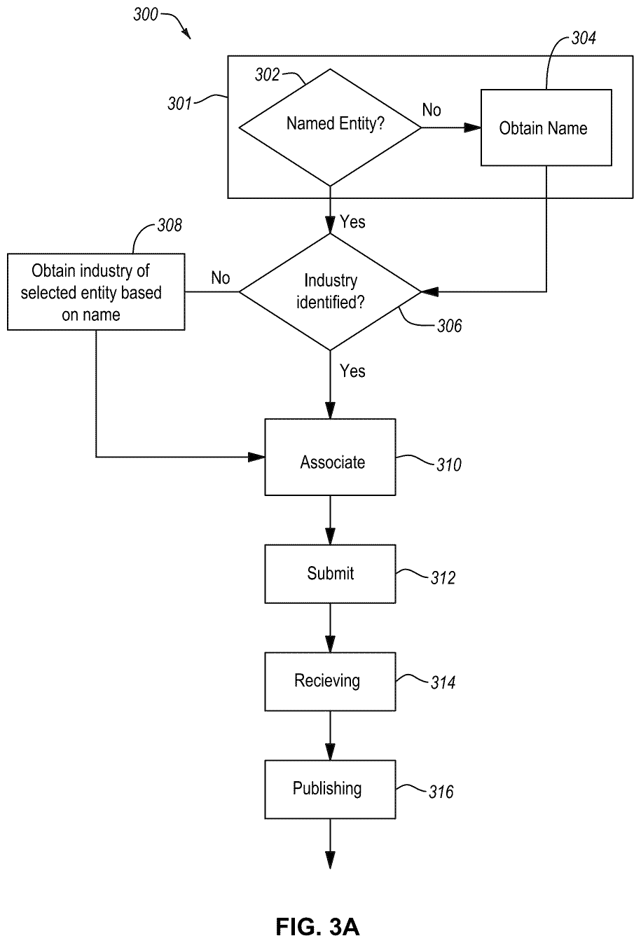

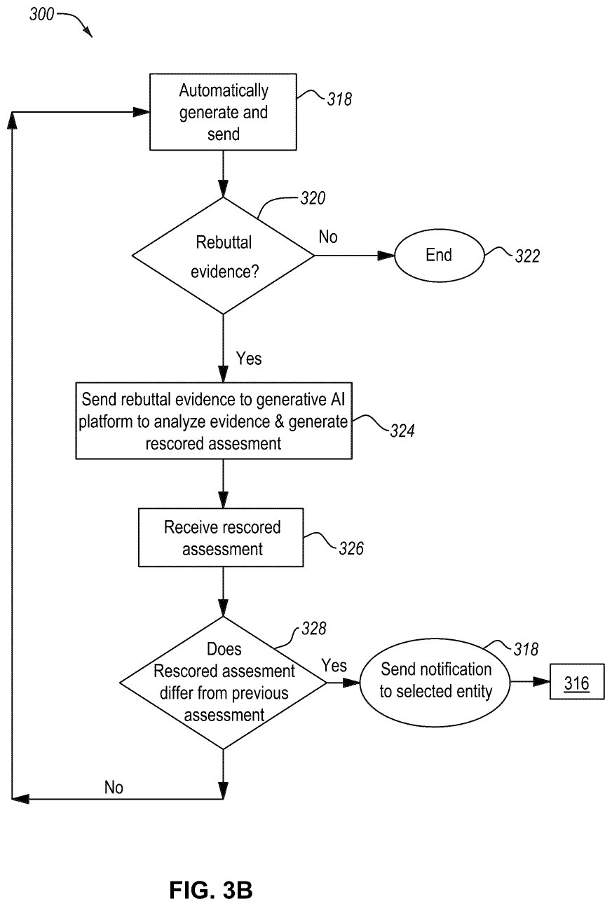

The method 100 may be carried out on the computing network 200 according to one or more algorithms. FIGS. 3A and 3B are a flow diagram of an algorithm 300 for auditing qualitative properties of an entity, according to an embodiment. Referring to FIGS. 3A-3B, the method 100 may be carried out as follows. The algorithm 300 includes machine readable and executable instructions for carrying out any of the acts of the method 100.

The algorithm 300 includes a first block 301 generating an audit request as disclosed herein. Generating the audit request may be carried out by a processor according to the act 130 disclosed herein. Generating the audit request may include block 302 where a processor determines if the selected entity is named. If the selected entity is not named, the algorithm 300 advances to the block 304 of obtaining a name for a selected entity. Block 304 may include a processor carrying out the act 110 (FIG. 1) disclosed herein, such as accessing one or more of email, a website, a database, or the like to obtain a name for a selected entity or entities.

Once the name of the selected entity is obtained, the audit request is generated, which causes the algorithm to advance to block 306 of determining if an industry is identified for the selected entity. Block 306 may be carried out by a processor according to the act 120 (FIG. 1) disclosed herein. For example, the determining if an industry is identified for the selected entity may include executing instructions to search for record of the industry corresponding to the name in the memory storage in the audit platform.

If the industry is not found in the memory storage, the algorithm 300 advances to the block 308 of obtaining the industry of the selected entity. Obtaining the industry of the selected entity may include executing instructions to search for and obtain the industry corresponding to the name as disclosed herein with respect to act 130 (FIG. 1), such as from an electronic source, such as a database, website, email communication, or the like.

Once the industry of the selected entity is obtained (e.g., associated with the name of the selected entity in the memory storage of the audit platform), the algorithm 300 advances to the block 310 of associating a set of predetermined search queries corresponding to the industry to the name of the selected entity. The block 310 of associating a set of predetermined search queries corresponding to the industry to the name of the selected entity may be carried out by the processor according to the act 140 (FIG. 1).

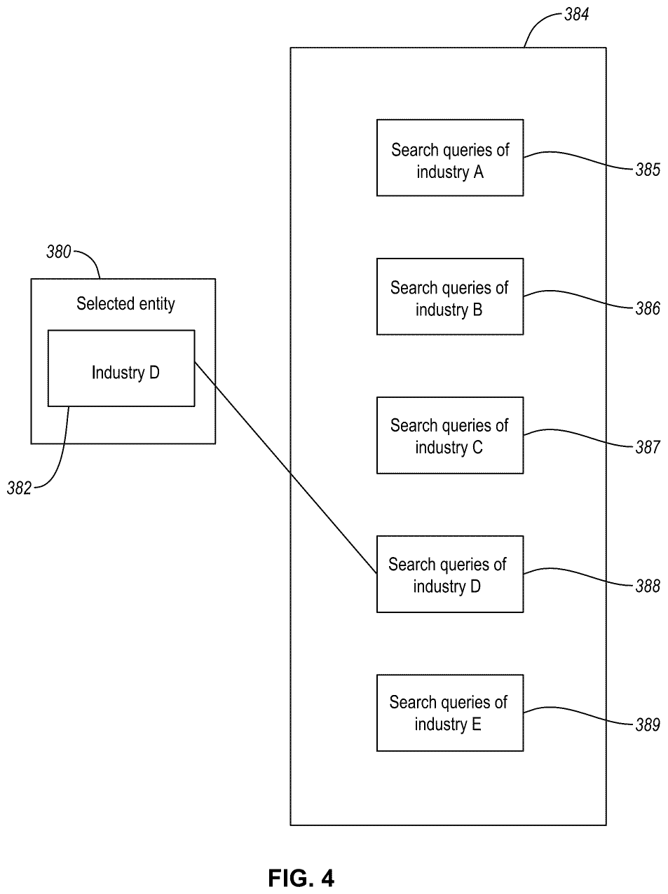

FIG. 4 is a block diagram illustrating associating a set of predetermined search queries corresponding to the industry to the name of the selected entity, according to an embodiment. Associating a set of predetermined search queries corresponding to the industry to the name of the selected entity may include correlating the industry of the selected entity to the name of the selected entity.

As shown in FIG. 4, block 310 of associating a set of predetermined search queries corresponding to the industry to the name of the selected entity may include identifying the predetermined set of search queries for the industry in a database 384 of sets of predetermined search queries 385-389. The database 384 may include sets of predetermined search queries 385-389 arranged by industry, such as by field, technology, product, service, or the like. The sets of predetermined search queries 385-389 may include machine readable and executable predetermined search queries, such as any search queries disclosed herein. Each of the sets of predetermined search queries 385-389 may contain predetermined search queries specific to a single selected industry. For example, a set of predetermined search queries may include standards qualifications for an industry, prompts to search for specific evidence of satisfaction of each of the standards qualifications by the selected entity, prompts to record location of the specific evidence, scoring criteria for each of the standards qualifications, or the like.

As shown, the name of the selected entity 380 may be correlated (e.g., electronically linked to) to the industry of the selected entity 382. The set of predetermined search queries corresponding to the industry may be identified in the database 384 based on the industry correlated to name of the selected entity 380. For example, the industry correlated to the name of the selected entity 382 may be electronically identified and matched to the same industry in the set of predetermined search queries. Based upon identification of industry, the corresponding set of predetermined search queries in the database 384 may be associated to the name of the selected entity (e.g., electronically duplicated with the name of the selected entity inserted therein in a separate file) for use in the audit of the selected entity. For example, the industry of the selected entity 382 may be correlated to the industry of the set of predetermined search queries 388 and the latter may be associated to the name of the selected entity.

Turning back to FIGS. 3A and 3B, once the name of the selected set of predetermined search queries corresponding to an industry is associated to a name of the selected entity, the algorithm proceeds to block 312 of submitting the set of predetermined search queries to a generative artificial intelligence platform with a prompt to apply the set of predetermined search queries to the name of the selected entity and to score satisfaction of the set of predetermined search queries according to the scoring criteria to produce the scored assessment. submitting the set of predetermined search queries to a generative artificial intelligence platform with a prompt to apply the set of predetermined search queries to the name of the selected entity and to score satisfaction of the set of predetermined search queries according to the scoring criteria to produce the scored assessment may be carried out as disclosed herein with respect to the act 150 (FIG. 1). The format may be prescribed by the set of predetermined search queries.

The algorithm 300 may advance to block 314 of receiving an electronic record of the scored assessment including the standards qualifications for the selected entity from the generative artificial intelligence platform. Receiving an electronic record of the scored assessment including the standards qualifications for the selected entity from the generative artificial intelligence platform may be carried out as disclosed herein with respect to the act 160 (FIG. 1).

The algorithm 300 may advance to block 316 of publishing the scored assessment to one or more entities. Publishing the scored assessment to one or more entities may be carried out as disclosed herein with respect to the act 170.

The algorithm 300 advances to the block 318 of automatically generating and sending an electronic invitation to the selected entity to electronically submit rebuttal evidence to support changing one or more portions of the scored assessment based on proof of satisfaction of one or more of the standards qualifications in the rebuttal evidence. Automatically generating and sending an electronic invitation to the selected entity may be carried out as disclosed herein with respect to the act 180 (FIG. 1).

The algorithm 300 advances to the block 320 of receiving the rebuttal evidence from the selected entity. Receiving the rebuttal evidence from the selected entity may include receiving no rebuttal evidence from the selected entity. In such circumstances, the algorithm advances to the block 322 and ends. The invitation may include a timed limit (e.g., at least 1 day, at least 1 week, at least 1 month, less than a year) for submitting rebuttal evidence. After the expiration of the time limit, a default assumption of no rebuttal evidence may be issued and the algorithm may be terminated at block 322.

Receiving the rebuttal evidence from the selected entity may include receiving rebuttal evidence from the selected entity, such as in the form of one or more of an image, a text file, a database, or the like. For example, the rebuttal evidence may include a photo or image of a document. Receiving the rebuttal evidence from the selected entity may include receiving the evidence on the audit platform via a link provided in the invitation, via an email address corresponding to the email domain of the selected entity or the like.

After receiving the rebuttal evidence, the algorithm 300 advances to the block 324 of sending rebuttal evidence to the generative artificial intelligence platform to rescore or regenerate the scored assessment taking the rebuttal evidence into consideration. For example, the block 324 may include submitting the rebuttal evidence to the generative artificial intelligence platform along with the set of predetermined search queries to the generative artificial intelligence platform with a prompt to (re)apply the set of predetermined search queries to the name of the selected entity, to (re)score satisfaction of the set of predetermined search queries according to the scoring criteria to produce the (re)scored assessment, and to (re)determine the risk score for the selected entity based on the (re)scored assessment, as disclosed herein with respect to the method 100.

The algorithm 300 advances to the block 326 of receiving an electronic record of the (re)scored assessment including the standards qualifications for the selected entity from the generative artificial intelligence platform in view of the rebuttal evidence. Such receipt may be similar or identical to the block 314 in one or more aspects.

The algorithm 300 advances to the block 326 of determining if the (re)scored assessment differs from an immediately previous scored assessment in one or more ways. Such a determination may be performed by electronically comparing content (e.g., text or scores) of the respective scored assessments. If there are differences between the scored assessments, the algorithm advances to the block 330 of sending a notification to the selected entity that the scored assessment has changed in view of the rebuttal evidence along with the scored assessment. The block 330 may include returning and repeating the block 316 with the (re)scored assessment and advancing through the remainder of the algorithm 300 after block 316 again.

If there are no differences between the scored assessments, the algorithm advances back to the block 318 of automatically generating and sending an electronic invitation to the selected entity to electronically submit rebuttal evidence to support changing one or more portions of the scored assessment based on proof of satisfaction of one or more of the standards qualifications in the rebuttal evidence as disclosed herein. If no more rebuttal evidence is received at block 320, the algorithm 300 ends at block 322. If more rebuttal evidence is received, the algorithm 300 continues through blocks 324-328 until no new rebuttal evidence is received.

The algorithm 300 is performed on the audit platform using inputs from one or more of the generative artificial intelligence platform, the client platform, the selected entity platform, or one or more public computing platforms.

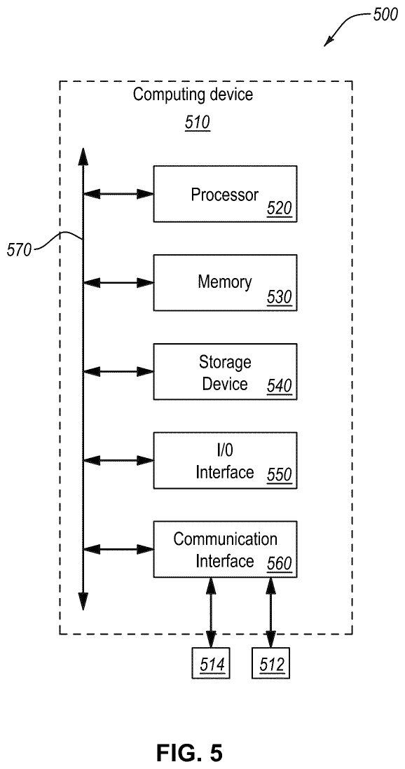

Any of the example systems disclosed herein may be used to carry out any of the methods disclosed herein, such as using a computing system. FIG. 5 is a schematic of a computing system 500 for executing any of the methods disclosed herein, according to an embodiment. The computing system 500 may be configured to implement any of the example methods disclosed herein, such as the method 100. The computing system 500 includes at least one computing device 510. The at least one computing device 510 is an exemplary computing device that may be configured to perform one or more of the acts described above, such as the method 100. The at least one computing device 510 can include one or more servers, one or more computers (e.g., desk-top computer, lap-top computer), or one or more mobile computing devices (e.g., smartphone, tablet, etc.). The computing device 510 can comprise at least one processor 520, memory 530, a storage device 540, an input/output (“I/O”) device/interface 550, and a communication interface 560. While an example computing device 510 is shown in FIG. 5, the components illustrated in FIG. 5 are not intended to be limiting of the computing system 500 or computing device 510. Additional or alternative components may be used in some examples. Further, in some examples, the computing system 500 or the computing device 510 can include fewer components than those shown in FIG. 5. For example, the computing system 500 may not include the one or more additional computing devices 512 or 514. In some examples, the at least one computing device 510 may include a plurality of computing devices, such as a server farm, computational network, or cluster of computing devices. Components of computing device 510 shown in FIG. 5 are described in additional detail below. The computing device 510 may be used for one or more of the audit platform 210 (FIG. 2), the client platform 220, the generative artificial intelligence platform 230, the selected entity platform 240, or the one or more public computing platforms 250.

In some examples, the processor(s) 520 includes hardware for executing instructions (e.g., instructions for carrying out one or more portions of any of the methods disclosed herein), such as those making up a computer program. For example, to execute instructions, the processor(s) 520 may retrieve (or fetch) the instructions from an internal register, an internal cache, the memory 530, or a storage device 540 and decode and execute them. In particular examples, processor(s) 520 may include one or more internal caches for data such as look-up tables. As an example, the processor(s) 520 may include one or more instruction caches, one or more data caches, and one or more translation lookaside buffers (TLBs). Instructions in the instruction caches may be copies of instructions in memory 530 or storage device 540. In some examples, the processor 520 may be configured (e.g., include programming stored thereon or executed thereby) to carry out one or more portions of any of the example methods disclosed herein.

In some examples, the processor 520 is configured to perform any of the acts disclosed herein such as in method 100 or cause one or more portions of the computing device 510 or computing system 500 to perform at least one of the acts disclosed herein. Such configurations can include one or more operational programs (e.g., computer program products) that are executable by the at least one processor 520. For example, the processor 520 may be configured to automatically execute any of the acts of the method 100 stored in the memory 530 as operational programs.

The at least one computing device 510 (e.g., a server) may include at least one memory storage medium (e.g., memory 530 and/or storage device 540). The computing device 510 may include memory 530, which is operably coupled to the processor(s) 520. The memory 530 may be used for storing data, metadata, and programs for execution by the processor(s) 520. The memory 530 may include one or more of volatile and non-volatile memories, such as Random Access Memory (RAM), Read Only Memory (ROM), a solid state disk (SSD), Flash, Phase Change Memory (PCM), or other types of data storage. The memory 530 may be internal or distributed memory.

The computing device 510 may include the storage device 540 having storage for storing data or instructions. The storage device 540 may be operably coupled to the at least one processor 520. In some examples, the storage device 540 can comprise a non-transitory memory storage medium, such as any of those described above. The storage device 540 may include a hard disk drive (HDD), a floppy disk drive, flash memory, an optical disc, a magneto-optical disc, magnetic tape, or a Universal Serial Bus (USB) drive or a combination of two or more of these. Storage device 540 may include removable or non-removable (or fixed) media. Storage device 540 may be internal or external to the computing device 510. In some examples, storage device 540 may include non-volatile, solid-state memory. In some examples, storage device 540 may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some examples, one or more portions of the memory 530 and/or storage device 540 (e.g., memory storage medium(s)) may store one or more databases thereon. At least some of the databases may be used to store one or more sets of predetermined search queries corresponding to selected industries, as disclosed herein.

In some examples, one or more sets of predetermined search queries corresponding to selected industries may be stored in a memory storage medium such as one or more of the at least one processor 520 (e.g., internal cache of the processor), memory 530, or the storage device 540. In some examples, the at least one processor 520 may be configured to access (e.g., via bus 570) the memory storage medium(s) such as one or more of the memory 530 or the storage device 540. For example, the at least one processor 520 may receive and store the data (e.g., locations of evidence, rebuttal evidence) as a plurality of data points in the memory storage medium(s). The at least one processor 520 may execute programming stored therein adapted access the data in the memory storage medium(s) to automatically perform any of the acts of the method 100. For example, the at least one processor 520 may access one or more one or more sets of predetermined search queries in the memory storage medium(s) such as memory 530 or storage device 540.

The computing device 510 also includes one or more I/O devices/interfaces 550, which are provided to allow a user to provide input to, receive output from, and otherwise transfer data to and from the computing device 510. These I/O devices/interfaces 550 may include a mouse, keypad or a keyboard, a touch screen, camera, optical scanner, network interface, web-based access, modem, a port, other known I/O devices or a combination of such I/O devices/interfaces 550. The touch screen may be activated with a stylus or a finger.

The I/O devices/interfaces 550 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces 550 are configured to provide graphical data to a display for presentation to a user. The graphical data may be representative of one or more graphical user interfaces and/or any other graphical content as may serve a particular implementation.

The computing device 510 can further include a communication interface 560. The communication interface 560 can include hardware, software, or both. The communication interface 560 can provide one or more interfaces for communication (such as, for example, packet-based communication) between the computing device 510 and one or more additional computing devices 512, 514, or one or more networks. For example, communication interface 560 may include a network interface controller (NIC) or network adapter for communicating with an Ethernet or other wire-based network or a wireless NIC (WNIC) or wireless adapter for communicating with a wireless network, such as a WI-FI.

Any suitable network and any suitable communication interface 560 may be used. For example, computing device 510 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, one or more portions of computing system 500 or computing device 510 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 510 may include any suitable communication interface 560 for any of these networks, where appropriate.

The computing device 510 may include a bus 570. The bus 570 can include hardware, software, or both that couples components of computing device 510 to each other. For example, bus 570 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

It should be appreciated that any of the acts described herein, such as in the method 100 may be performed by and/or at the computing device 510.

The methods and systems disclosed herein provide automatic auditing of qualitative properties of a selected entity extremely fast and at scale with expertise that was previously only available to one assessment at a time on a days, weeks, or even months long basis. The methods and systems disclosed herein also provide consistent scored assessments of entities (e.g., companies, products) across an industry (e.g., field, service, product category). By leveraging machine readable and executable interactions with, and using, generative artificial intelligence tools to automatically process sets of predetermined search queries corresponding to selected industries, the methods and systems disclosed herein provide accurate auditing of qualitative properties of a selected entity on a minutes or seconds timeline.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method of auditing qualitative properties of an entity, the method comprising:
generating an audit request including a scored assessment for a selected entity;
associating a set of predetermined search queries corresponding to an industry to a name of the selected entity, the set of predetermined search queries including standards qualifications for the industry of the selected entity, prompts to search for specific evidence of satisfaction of each of the standards qualifications by the selected entity, prompts to record a location of the specific evidence, and scoring criteria for each of the standards qualifications;
submitting the set of predetermined search queries to a generative artificial intelligence platform with a prompt to apply the set of predetermined search queries to the name of the selected entity and to score satisfaction of the set of predetermined search queries according to the scoring criteria to produce the scored assessment;
receiving an electronic record of the scored assessment including the standards qualifications for the selected entity from the generative artificial intelligence platform;
publishing the scored assessment to one or more entities; and
automatically generating and sending an electronic invitation to the selected entity to electronically submit rebuttal evidence to support changing one or more portions of the scored assessment based on proof of satisfaction of one or more of the standards qualifications in the rebuttal evidence.

2. The method of claim 1 wherein generating an audit request including a scored assessment for a selected entity includes obtaining the name of the selected entity from an electronic source, including one or more of a database, website, direct electronic input, or electronic mail.

3. The method of claim 1 further comprising automatically determining the industry of the selected entity.

4. The method of claim 1 wherein automatically determining the industry of the selected entity includes executing instructions to search for and obtain the industry from an electronic source.

5. The method of claim 1 wherein the selected entity is a product, company, or service.

6. The method of claim 1 wherein submitting the set of predetermined search queries to a generative artificial intelligence platform with a prompt to apply the set of predetermined search queries to the name of the selected entity and to score satisfaction of the set of predetermined search queries according to the scoring criteria to produce a scored assessment includes submitting one or more limitations upon data sources from which the generative artificial intelligence platform is permitted to reference in answering the set of predetermined search queries.

7. The method of claim 1 wherein submitting the set of predetermined search queries to a generative artificial intelligence platform with a prompt to apply the set of predetermined search queries to the name of the selected entity and to score satisfaction of the set of predetermined search queries according to the scoring criteria to produce the scored assessment includes format instructions configured to prompt the generative artificial intelligence platform to output a response in a selected format.

8. The method of claim 7 wherein the selected format includes one or more of text format output for the scored assessment, file format output for the scored assessment, or information supplied in the scored assessment.

9. The method of claim 1 wherein the scoring criteria for each of the standards qualifications includes weights corresponding to each of the standards qualifications and rules for calculating the scored assessment.

10. The method of claim 1 wherein receiving an electronic record of the scored assessment of the standards qualifications for the selected entity from the generative artificial intelligence platform includes receiving one or more of a score of each of the set of predetermined search queries, a total score of all of the set of predetermined search queries, at least one sub-score of at least one subset of the set of predetermined search queries grouped by a category of the standards qualifications.

11. The method of claim 1 wherein:
submitting the set of predetermined search queries to a generative artificial intelligence platform with a prompt to apply the set of predetermined search queries to the name of the selected entity includes submitting a prompt to determine a risk score for the selected entity based on the scored assessment; and
receiving an electronic record of the scored assessment of the standards qualifications for the selected entity from the generative artificial intelligence platform includes receiving the risk score.

12. The method of claim 1 wherein publishing the scored assessment to one or more entities includes automatically communicating an electronic copy of the scored assessment to one or more of an audit requesting entity or the selected entity.

13. The method of claim 1 wherein automatically generating and sending an electronic invitation to the selected entity to electronically submit rebuttal evidence to support changing one or more portions of the scored assessment based on proof of satisfaction of one or more of the standards qualifications in the rebuttal evidence includes automatically generating and sending an electronic link to submit rebuttal evidence that is electronically linked to the scored assessment in an auditor computing device.

14. A system for generating and disseminating audit assessments, the system comprising:
a computing device including,
a memory storage on a non-transitory memory storage medium containing one or more operational programs including machine readable and executable instructions; and
a processor operably to and configured to access the memory storage and execute the one or more operational programs, wherein the one or more operational programs including instructions to:
generate an audit request including a scored assessment for a selected entity;
associate a set of predetermined search queries corresponding to an industry to a name of the selected entity, the set of predetermined search queries including standards qualifications for the industry of the selected entity, prompts to search for specific evidence of satisfaction of each of the standards qualifications by the selected entity, prompts to record a location of the specific evidence, and scoring criteria for each of the standards qualifications;
submit the set of predetermined search queries to a generative artificial intelligence platform with a prompt to apply the set of predetermined search queries to the name of the selected entity and to score satisfaction of the set of predetermined search queries according to the scoring criteria to produce the scored assessment;
receive an electronic record of the scored assessment including the standards qualifications for the selected entity from the generative artificial intelligence platform;
publish the scored assessment to one or more entities; and
automatically generate and send an electronic invitation to the selected entity to electronically submit rebuttal evidence to support changing one or more portions of the scored assessment based on proof of satisfaction of one or more of the standards qualifications in the rebuttal evidence.

15. The system of claim 14 wherein the machine readable and executable instructions to generate an audit request including a scored assessment for a selected entity include instructions to obtain the name of the selected entity from an electronic source, including one or more of a database, website, direct electronic input, or electronic mail.

16. The system of claim 14 wherein the machine readable and executable instructions to submit the set of predetermined search queries to a generative artificial intelligence platform with a prompt to apply the set of predetermined search queries to the name of the selected entity and to score satisfaction of the set of predetermined search queries according to the scoring criteria to produce a scored assessment includes instructions to submit one or more limitations upon data sources from which the generative artificial intelligence platform is permitted to reference in answering the set of predetermined search queries and format instructions configured to prompt the generative artificial intelligence platform to output a response in a selected format.

17. The system of claim 14 wherein the machine readable and executable instructions to receive an electronic record of the scored assessment of the standards qualifications for the selected entity from the generative artificial intelligence platform includes instructions to receive one or more of a score of each of the set of predetermined search queries, a total score of all of the set of predetermined search queries, at least one sub-score of at least one subset of the set of predetermined search queries grouped by a category of the standards qualifications from the generative artificial intelligence platform.

18. The system of claim 14 wherein the machine readable and executable instructions to:
submit the set of predetermined search queries to a generative artificial intelligence platform with a prompt to apply the set of predetermined search queries to the name of the selected entity includes instructions to submit a prompt to determine a risk score for the selected entity based on the scored assessment; and
receive an electronic record of the scored assessment of the standards qualifications for the selected entity from the generative artificial intelligence platform includes instructions to receive the risk score from the generative artificial intelligence platform.

19. The system of claim 14 wherein the machine readable and executable instructions to publish the scored assessment to one or more entities includes instructions to automatically communicate an electronic copy of the scored assessment to one or more of an audit requesting entity or the selected entity.

20. The system of claim 14 wherein the machine readable and executable instructions to automatically generate and send an electronic invitation to the selected entity to electronically submit rebuttal evidence to support changing one or more portions of the scored assessment based on proof of satisfaction of one or more of the standards qualifications in the rebuttal evidence includes instructions to automatically generate and send an electronic link to submit rebuttal evidence that is electronically linked to the scored assessment in a provider computing device.

21. The system of claim 14 wherein the computing device includes one or more application programming interfaces stored thereon, the one or more application programming interfaces include machine readable and executable instructions for communication between the computing device and one or more of an audit requestor, the selected entity, or the generative artificial intelligence platform.

22. A method of auditing qualitative properties of an entity, the method comprising:
obtaining a name of a selected entity from an electronic source, including one or more of a database, website, direct electronic input, or electronic mail;
automatically determining an industry of the selected entity;
generating an audit request including a scored assessment for the selected entity;
associating a set of predetermined search queries corresponding to the industry to a name of the selected entity, the set of predetermined search queries including standards qualifications for the industry of the selected entity, prompts to search for specific evidence of satisfaction of each of the standards qualifications by the selected entity, prompts to record a location of the specific evidence, scoring criteria for each of the standards qualifications, and criteria for determining a risk score for the selected entity based on the scored assessment;
submitting the set of predetermined search queries to a generative artificial intelligence platform with a prompt to apply the set of predetermined search queries to the name of the selected entity, to score satisfaction of the set of predetermined search queries according to the scoring criteria to produce the scored assessment, and to determine the risk score for the selected entity based on the scored assessment;
receiving an electronic record of the scored assessment including the standards qualifications for the selected entity from the generative artificial intelligence platform;
publishing the scored assessment to one or more entities; and
automatically generating and sending an electronic invitation to the selected entity to electronically submit rebuttal evidence to support changing one or more portions of the scored assessment based on proof of satisfaction of one or more of the standards qualifications in the rebuttal evidence.
